(19) United States
(12) Patent Application Publication
(10) Pub. No.: US 2011/0196692 A1
(43) Pub. Date: Aug. 11, 2011

(54) APPARATUS, SYSTEM AND METHOD FOR GRID STORAGE

(76) Inventors: Lloyd G. Chavez, JR., Castle Rock, CO (US); Michael Henry, Parker, CO (US); John Rogers Bryan, Denver, CO (US)

(21) Appl. No.: 13/024,299

(22) Filed: Feb. 9, 2011

Related U.S. Application Data
(60) Provisional application No. 61/302,923, filed on Feb. 9, 2010.

(51) Int. Cl. G06F 1/28; G06Q 30/00

(52) U.S. Cl. 705/1.1; 700/297

(57) ABSTRACT

A system and method of grid storage to provide various possible services upon request or otherwise. The system may involve a plurality of fleet vehicle or other vehicles with an electric drive train and some form of energy storage, such as batteries. The vehicles are aggregated in a common location while connected to the grid and the system has control over and otherwise manages the collection of storage assets to provide the service. Further, a third party system may control and otherwise own the battery resources. In such an arrangement, the third party system may receive remuneration from a utility or the like for provision of the requested service and the third party system may also receive remuneration from the vehicle owner for use of the battery system.

### CROSS-REFERENCE TO RELATED APPLICATION

The present non-provisional utility application claims priority under 35 U.S.C. §119(e) to co-pending provisional application No. 61/302,923 titled “System and Method for Maximizing Storage and Power Generation Income Streams,” filed on Feb. 9, 2010 and which is hereby incorporated by reference.

### FIELD OF THE INVENTION

Aspects of the present invention involve an energy storage system and related methods for providing ancillary or other services to a grid, transportation costs hedging, and electrical demand management, among other aspects.

### BACKGROUND

Environmental impacts, global conflicts, and rising oil prices, among others, are motivating investment and dramatic technologic improvements in green or clean energy. For example, wind farms and photovoltaic arrays are being deployed throughout the United States. From 2000-2010, the installed wind capacity has increased from about 495 megawatt hours (MWh) to over 1,195 gigawatt hours (GWh), with wind providing about 2% of the overall capacity in the United States and projected to provide 20% by 2030. Currently, some Federal government officials are advocating increasing investment in wind and solar such that they and other clean energies provide up to 85% of overall capacity by 2035.

While wind and solar provide clean sources of energy, there are some drawbacks. Primarily, wind and solar are intermittent—depending on blowing wind and sunny skies to produce energy. When intermittent fluctuations occur, such as when the wind stops blowing, it has negative impacts on the overall grid. To address these impacts, generation and transmission must be managed to match renewable supply fluctuations, in addition to conventional fluctuations due to customer load and unexpected outages. Currently, the bulk of these fluctuations are managed by use of generators that are either turned on and off, or kept on at all times but only providing energy when requested. Cycling generators on and off, or leaving them idle until needed, is capital and energy inefficient, environmentally unfriendly and costly but nonetheless is presently necessary to maintain the quality of service expected of the electric grid.

At the same time that renewable energy sources are being rapidly added to provide power to the grid, storage technology generally and battery storage capacity and cycle life particularly are improving rapidly. Improvements in battery power have been spurred in large part by growth in portable computing devices and hybrid and full electric vehicles. Stationary battery systems thus have been proposed and in some instances put in place for purposes of various ancillary utility services. Addressing fluctuations in the grid is often referred to as an ancillary service among which include spinning reserves that provide power to the grid in order to address fluctuations and frequency regulation. In such instances, the battery arrays are used strictly as grid storage.

With improvements in battery technology and growth of hybrid and electric vehicles, various distributed vehicle-to-grid (V2G) technologies have been proposed and developed. Generally speaking, V2G solutions often envision individual hybrid or electric vehicles coupled with some form of charging station at homes or elsewhere that can draw energy from the charging station to charge batteries as well as provide energy back to the charging station and thereto to the grid or otherwise for provision of primary generation (i.e., usable energy) as opposed to ancillary or other services.

When such highly distributed small vehicle systems are considered for storage solutions to provide ancillary services, several significant hurdles exist. For example, electric vehicle battery systems and capacities are designed for and must be available for various possible daily driving schedules, whether a 60-mile round trip to the office or a quick trip the grocery store. Hybrid battery systems are conventionally relatively small and are not relied upon for long round trips. Moreover, recharging such systems are usually very slow due to the increased costs of high power batteries and associated high voltage and high current electrical connections. Thus, charging often occurs overnight and takes several hours in order to ensure that the vehicle is fully charged and available in the morning. This is due in some part to the fact that very few third-party charging facilities are available outside the home; hence, there is not an opportunity to pay to recharge a battery system while the vehicle is parked at the office or a grocery store, for example. With these things in mind, commercially viable distributed storage solutions involving electric or hybrid light duty vehicles face numerous hurdles and are currently impractical.

### SUMMARY

One aspect of the present disclosure involves a method of providing storage to a grid and provides a service using the storage. The method is performed by at least one computing device in communication with at least one tangible storage media, the tangible storage media including computer executable instructions arranged to perform the method. The method involves the operations of receiving information from a plurality of vehicle storage systems, the information including an indication the availability of the plurality of vehicle storage systems ability to provide at least one energy service. The method further involves transmitting a first signal to a utility computing system indicative of the plurality of vehicle storage systems availability to provide the at least one energy service. From the utility computing system, which may be provided at a utility company, other energy provider, or energy consumer, receiving a second signal from the utility computing system requesting the at least one service. Finally, the method involves transmitting a third signal to the one or more of the plurality of vehicle storage systems to provide the at least one requested service.

The method may further involve receiving information from the plurality of vehicle storage systems including a battery system with storage capacity sized for provision of at least one energy service, the information including an indication of the state of charge of the battery system, the plurality of vehicle storage systems associated with a respective plurality of vehicles. Additionally, the method may involve receiving remuneration from at least one owner of the plurality of vehicles for use of the respective plurality of vehicle storage systems and receiving remuneration form the utility computing system for providing the at least one requested service.

Another aspect of the present disclosure involves a system for providing grid storage. The system involves at least one computing device in communication with a plurality of battery control computing nodes configured to communicate with to a plurality of vehicle drive battery systems. The at least one computing device is further configured to receive information concerning the plurality of vehicle drive battery systems, the information including a state of charge of the plurality of vehicle drive battery systems. Additionally, the at least one computing device is configured to transmit vehicle drive battery system scheduling information to a utility energy provider computing system, the scheduling information including information indicative of availability of the plurality of vehicle drive battery systems to provide at least one service. Finally, the at least one computing device is also configured to receive a request from the utility energy provider computing system to provide the at least one energy service, the at least one computing device signaling the plurality of battery control computing nodes to control provision of the at least one energy service from the plurality of vehicle drive battery systems.

Another aspect of the present disclosure involves a system for providing grid storage comprising at least one computing device in communication with a plurality of battery control computing nodes configured to connect to a plurality of vehicle drive battery systems, the at least one computing device associated with an owner of the vehicle drive battery systems, the at least one computing device configured to receive remuneration for use of the plurality of vehicle drive battery systems from at least one owner of a plurality of vehicles associated with the plurality of vehicle drive battery systems that provide motive power to the plurality of respective vehicles. The at least one computing device may further be configured to receive information concerning each vehicle drive battery system, the information including a state of charge and to transmit vehicle drive battery system scheduling information to a utility energy provider computing system, the scheduling information including information indicative of availability of the plurality of vehicle drive battery systems to provide at least one service. Additionally, the at least one computing device may further be configured to receive a request from the utility energy provider computing system to provide the at least one service, the at least one computing device providing a service signal to the plurality of battery control computing nodes to control provision of the at least one energy service from the plurality of vehicle drive battery systems, the at least one computing device further configured to receive remuneration from the utility energy provider computing system for the provision of the at least one energy service.

### BRIEF DESCRIPTION OF THE DRAWINGS

Example embodiments are illustrated in referenced figures of the drawings. It is intended that the embodiments and figures disclosed herein are to be considered illustrative rather than limiting.

FIG. 1 is a system diagram illustrating one possible implementation of an energy storage system conforming to aspects of the present invention;

FIG. 2 is a flowchart illustrating one possible method of provisioning energy storage and providing ancillary services with the storage;

FIG. 3 is a system diagram illustrating one possible implementation of an energy storage system conforming to aspects of the present invention, the system including a third-party server and owner associated with battery systems of vehicles; and

FIG. 4 is a system diagram illustrating one possible implementation of an energy storage system conforming to aspects of the present invention, the system including a third-party server and owner associated with battery systems of vehicles.

### DETAILED DESCRIPTION

Aspects of the present disclosure involve methods and systems for providing energy storage and providing various possible ancillary and other grid services using the storage. In one particular arrangement, the system includes vehicles with battery based storage systems provided in a common location or otherwise under common control. The system views the battery systems as a collective or otherwise aggregate storage resource that can be deployed to provide various possible grid and other energy services. Additionally, the vehicles are connected to the grid or other energy source or user in a schedulable manner, with scheduling information being transmitted or otherwise provided to utilities, other energy providers, or other energy sources or users. While connected, the storage systems may be charging or otherwise idle when not providing a service. Further, the status of each battery system, such as the state of charge, is available to a computing device or devices in communication with the pool of storage assets. Based on the scheduling information as well as a need for a service, a computing device or devices (e.g., computing devices associated with a utility company or other energy provider or user) transmit requests to the storage computing device such that the stored energy of the storage systems provides the requested service.

By providing a pool of storage assets under common control, the system has sufficient storage capacity to provide the service. In one implementation, a large heavy duty fleet vehicle, such as a school bus, provides the platform for the battery system. It is also possible to have a third party own the battery system, and to provision the battery system such that it is larger than is necessary for the daily mileage schedule of the vehicle and hence optimized not for vehicle transportation but rather for utility energy storage. Unlike a smaller vehicle where larger battery systems translate to longer range but vehicle frame space limits the battery size, a bus platform has substantially more volumetric frame space to accommodate a battery system that is of greater size than is necessary for just transportation. However, optimizing the battery for storage and provision of grid or other services warrants the added expense for the extra battery capacity while providing an ancillary benefit of much greater range to the user. Additionally, providing vehicles at a common location for the provision of services adds expenses of higher capacity charge and discharge capability relative to a consumer application but allows those added costs to be shared across the pool of resources.

Since most vehicle operators do not provide electric power regulation or energy supply to their interconnected grid, they do not have the experience or financial capability to justify the added costs of electric vehicles or their necessary service infrastructure. In addition, in some instances, the added capital expenditure is not possible for a school district or the like, and hence the third party owner can purchase the battery and lease or rent it to the vehicle owner for transportation use. In such a situation, a form of fuel hedge may also be provided such that the battery system user automatically remits a scheduled payment to the battery owner (and computing system thereof) at a fixed amount as opposed to paying the current price of electricity, diesel, or gasoline. Hence, variable diesel, gasoline or other conventional and variable fuel prices are not only eliminated but the fleet operator has a fixed and predictable expense for the period of the battery system use. In one particular example, the rate is fixed and based on mileage. Moreover, such a situation actually reduces the overall bus capital and operations cost for the school district or other fleet provider or owner compared to purchasing and owning an electric or conventional diesel vehicle in a conventional arrangement. Additionally, providing a pool of energy storage assets under common control to provide the service with the vehicle storage assets optimized and oversized for storage often times means that particular storage assets are not deeply discharged while providing services even if the vehicle is connected to the grid after driving and at a state of discharge less than full. Shallower discharges will extend the life of batteries even beyond manufacturer stated warranty profiles.

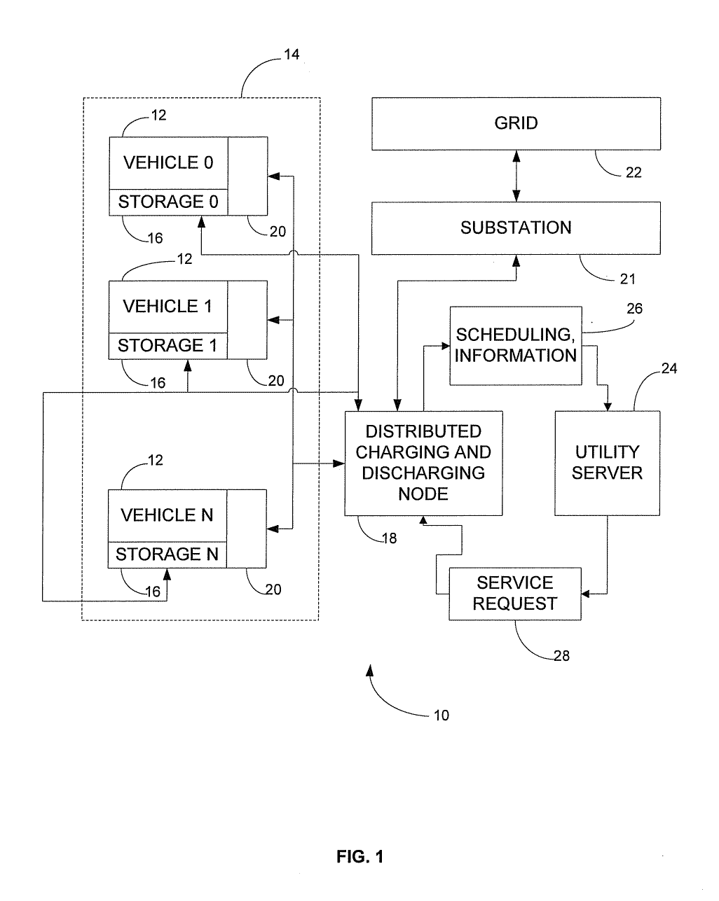

FIG. 1 is a diagram of a grid energy storage system 10 conforming to aspects of the present disclosure. In this system, a plurality of hybrid or electric vehicles 12 are aggregated in a common location 14. Additionally, the storage capacity from all of the vehicle storage systems 16 aggregated in the common location is viewed and deployable by the system collectively or in various combinations. The vehicles may be of various possible sizes and may include various possible capacity storage systems. Some examples of vehicle types and aggregation locations particularly amendable to the system and method set out herein include school buses, as mentioned above, that are typically parked in a common location, large scale delivery operations with vehicles being deployed from a central location, and the like.

In one particular example, the vehicles are electric school buses with battery systems of a relatively large capacity that can take advantage of the large vehicle frame of a typical school bus. The vehicles, whether school buses or otherwise, may be retrofitted with an electric drive train or may come from the factory directly with an electric drive train. In one particular implementation, the vehicles include 400 kilowatts (0.4 MW) or 92 kWh of total energy storage in the form of lithium ion based battery cells arranged in a battery pack. Keeping with the bus example, 36 buses in a common lot would have up to 14.4 MW or 3,312 kWh of available capacity. In other alternatives, vehicles may be provided with one or more flywheels or other forms of energy storage.

In a bus battery storage system, the capacity is far greater than current production electric or hybrid vehicles (e.g., 24 kWh estimated for one current production electric vehicle or 1.3 kWh estimated for a one current production hybrid vehicle). Hence, the bus storage capacity is significantly greater than conventional electric or hybrid vehicles. In the particular example of a school bus based electric drive platform several advantages are realized. In many situations, the majority of a bus fleet for school districts during a given day while the buses are transporting children to and from school is parked in the same location except for 3 hours per day and only used 183 days per year. Additionally, while parked, the buses are aggregated in one or more common lots.

In any given implementation, the energy storage capacity of the vehicle may be optimized for distributed energy storage and provision of services as opposed to transportation. Hence, for example, in the case of United States' public school buses, a given bus route averages 20 miles in the morning and 20 miles in the afternoon. Presumably, the bus is on charge between the morning and afternoon routes and able to recharge much of the energy used in the morning route. Hence, storage capacity to provide 30 miles with a margin for error may be required. However, for energy storage, a larger capacity battery is beneficial but the cost of which is not necessarily warranted for transportation requirements. In one possible implementation, a 73-mile range pack such that is provided and less than 50% of that capacity would typically be used for transportation. Additionally, in one possible implementation, each bus would include a 92 kWh battery system divided into two distinct packs with each pack composed of 4.17C battery cells at a total of 240V for each pack. The vehicle packs would charge (or discharge) through a 400 kW NEMA compliant plug in about 15 minutes from a level of about 80% discharge or greater. This has several benefits when the battery size as well as the electrical infrastructure is optimized for storage rather than transportation. For example, deep discharges of the pack are well known to negatively impact overall storage capacity over time. A pack optimized for storage and hence with a larger capacity than warranted for transportation has greater reserve capacity available for provision of services without deeply discharging the battery. Additionally, the expense and necessary infrastructure for high speed charging is more effectively deployed in a centralized and controlled location.

At the aggregation location 14, the system includes a charge/discharge computing node and grid connecting electronics 18 for collectively managing the charge and discharge of each vehicle within the aggregation location. The provision of a service may involve having sufficient capacity available for discharging packs to the grid as well as charging packs (pulling energy from the grid). Additionally, the node may include power electronics sufficient to convert DC power from the battery to AC power synchronized to the grid or in order to synchronize the grid. It should be noted that the node may include one or more processors, memory, power, and communication electronics (wireless or wired) to receive and provide commands and information and other functionality. Moreover, the node may be provided in a single module or may be distributed in a plurality of modules. Moreover, some functionality may be provided in a processor and other electronics in the vehicle. Further, power electronics, AC to DC conversion, DC to AC conversion, and switches to couple and control the flow of current to and from vehicle storage may be provided at charging ports 20.

As referenced above relative to the bus example, the node has access to up to 14.4 MW or 3,312 kWh of available capacity when 36 buses are aggregated at the node 18. Each vehicle 12 is in communication with the node, and each vehicle includes a dedicated charge and discharge connection to the vehicle's battery storage system 16. The vehicle and/or the storage system includes a processor and related electrical components that monitor and record various battery system parameters such as state of charge, pack voltage, individual cell or module voltages, input current, output current, and historical operating conditions. The battery system processor and components may further be configured to control alone or in conjunction with the charge port when the battery system is connected to a charge port to receive energy and when the battery system is connected to the power outlet to distribute energy. Hence, each vehicle may be individually charged or discharged, or various sets of vehicles may be charged or discharged as groups depending on what service is required and what available capacity and status for the various storage systems are available to the node.

The systems and methods discussed herein may be used to provide various possible grid or other energy services. Examples of such services include, but are not limited to, spinning reserves, frequency regulation, load following, demand charge management, renewable energy time shifting, electrical supply capacity, wind generation integration (short and long duration), electric service reliability, electric service power quality, voltage support, transmission congestion relief, transmission support, T&D upgrade deferrals, area regulation, electric supply reserve capacity, and substation on-site power. These and other services are discussed in “Energy Storage for the Electricity Grid: Benefits and Market Potential Assessment Guide—A study for the DOE Energy Storage Systems Program” by Jim Eyer and Garth Corey (February 2010) (SAND2010-0815), which is hereby incorporated by reference herein.

The battery system processor, the port 20 and/or other components are configured to communicate with the node 18. Such communication may be performed through a physical connection, wirelessly, or some combination thereof. Such communication may also be encrypted or otherwise include other security protocols. In any event, battery system information may be transmitted to the node, control signals may be transmitted to the node, the vehicle may receive information from the node, and the vehicle may receive commands from the node. FIG. 1 illustrates a connection between the storage resources 16, the node 18 and a substation 21 and the grid 22. Energy from storage may be exchanged through the grid using other possible routes and components. For example, the node may communicate with the ports 20, and the ports may be connected to the substation 21 or some other portion of the grid 22. In such and arrangement, energy is routed through the ports to the grid rather than through the node 18.

The provision of a common node with communication and control to and from individual vehicles also allows energy to be transferred among vehicle storage systems. For example, if power to the lot was unavailable for any number of possible reasons, energy could be exchanged between discharged battery systems and that of more fully charged battery systems. Moreover, such inter aggregation point power distribution may be done on a DC basis without converting to AC and then converting back to DC, which is more efficient. Moreover, the common node along with the vehicles may be deployed physically or logically to provide peak demand power, emergency back up power, and the like. For example, a node may be moved to or otherwise provided at a laboratory that has intermittent high power requirements (above average day-to-day requirements) or to a stadium during an event when lighting and the like require much higher than average power requirements.

In one particular implementation, the node views the collection of all vehicles coupled with the node as a scalable and deployable energy storage resource. Hence, keeping with the 36-bus example, up to 14.4 MW are available for provision of services. Depending on the service requested and the storage resources available as well as other factors, the node 18 may provision some or all of the storage assets to provide a requested service. Moreover, the node may provision some storage resources for provision of a first service, other storage resources for provision of a second service, and so on. Further, the node may include other information that effects its provisioning of storage assets to provide a service. For example, a vehicle owner may require battery systems to not discharge below a minimum level, and such a requirement is considered when provisioning storage to provide storage. It is also possible that some storage assets might be involved with providing a service that involves storing energy in the batteries whereas other storage assets might be involved with providing a service that involves delivering energy from the batteries, which may occur at the same time under node control 18.

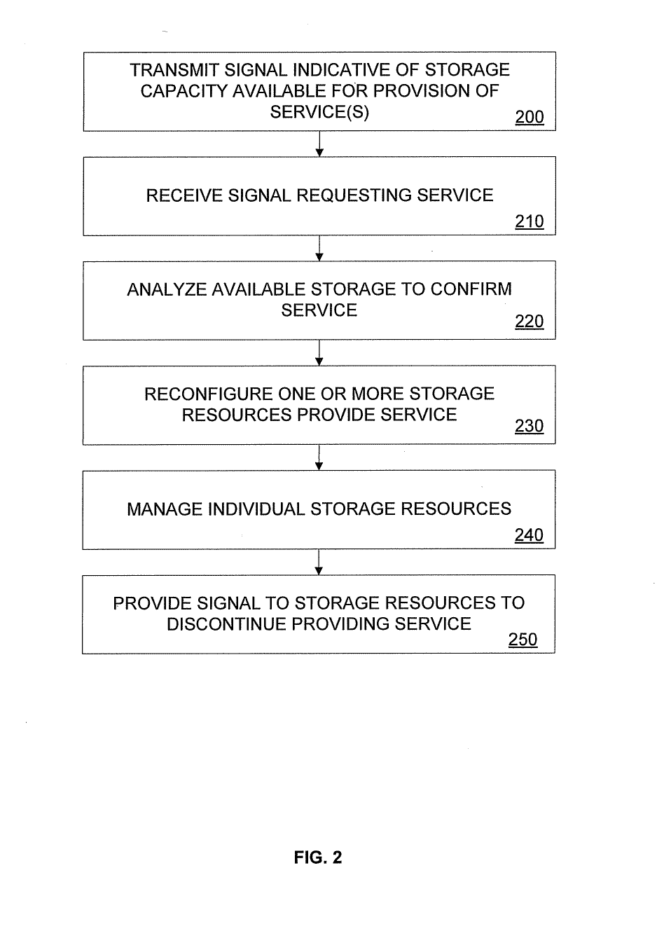

The node is in communication with a computing system 24 of an energy provider such as a utility company. FIG. 2 is one possible method providing one or more services using the system of FIG. 1. The utility computing system is configured to receive scheduling information 24 from the node (operation 200). Scheduling information identifies the available storage that may be provisional to provide a service. While the method is discussed with reference to a computing system of a utility company, the node may communicate scheduling information and other information, and receive services requests and other information from the computing systems that might be involved with providing a service.

In one implementation, the node identifies each the total battery capacity available at the node that may be provisional to provide a service. The node could take into account various factors including state of charge of each individual battery pack, the time of day, and a schedule of when the vehicle will be disconnected for transportation, maintenance, or otherwise. The schedule in the case of a school bus fleet would include times when the bus will be used for student transport to and from school and times when the bus will be used for special events. The node may also maintain a record of measured vehicle use patterns as well as user preferences. For example, it may be required that the vehicle never be discharged below some percent state of charge. The node may also receive and account for contracted or market value of various possible services that the storage could provide. It is contemplated that many light, medium and heavy-duty vehicle types could be candidates for provisioning energy storage for grid support in addition to school buses. Their accommodation of large battery packs with defined schedules and adequate availability would apply to such vehicles as short-haul warehouse distribution trucks, delivery trucks, forklifts and ships, for example.

These various factors, along or in combination, as well as others, may be used by the node to transmit scheduling information 26 to the utility computing device. Hence, in one specific example, the node may transmit scheduling information to the utility computing device on an hourly basis. In the 36 bus example, when all buses are connected, the node might transmit scheduling information indicating that some or all of the 14.4 MW of total capacity are available for provision of a service. In turn the node would be taking into account factors suggesting that the all of the 36-bus batteries would be available to provide the service for the next hour, which might be the case during late night and early morning hours or on weekends and holidays. In the following hour, the node would reassess the information used in generating the scheduling information, and transmit a new schedule. If one of the buses was electronically scheduled in the node computing system to be disconnected for a Saturday morning field trip, the system would adjust the scheduling information based on the capacity of the 35 remaining buses. Similarly, if the electrical connection or communication with a bus battery system failed, the node would identify the failure, and send updated schedule information to the utility computing system immediately (rather than at the next hour interval) accounting for the unscheduled or otherwise unpredicted loss of one of the battery systems.

One advantage of a centralized fleet of vehicles with energy storage, or a plurality of centralized fleets in communication as discussed herein, is that the vehicles may be predictably scheduled in terms of service availability. Further, depending on the fleet operation, it may also be possible to arrange the fleet such that services may be provided on a 24 hour, 7-day basis. For example, day and night operations of a fleet might be segregated on a vehicle basis and in communication with distinct nodes. Hence, day operation vehicles are coupled to a first node and night operation vehicles are coupled to a second node (the first and second nodes being physical or logic nodes) such that some number of predictable and hence schedulable storage resources are coupled with a node at all times of the day. The same effect can be achieved with a single node or other arrangements of nodes and by identifying vehicles as they connect and disconnect to the node and an associated charging port, or are otherwise available for provision of services.

The utility provider or other energy provider and particularly a computing system associated with the same, transmits a signal 28 requesting a service (operation 210). In one example, the utility's computing system transmits an automated generation central (AGC) signal to the storage system node 18. The AGC includes the total requested power for a standard time duration for the energy service. The signal will adjust over or following duration increment based upon the utility provider needs in the system. The control signal includes of a date stamp and a percentage of the power level agreed to be supplied. In other cases, the signal has been pre-negotiated via contract and is merely a tracking identifier and a “go” code. The signal may be communicated to the node under various possible communication forms including a wired network, a wireless network, and a combination of wire and wireless networks. The distributed charging and discharging node receives the signal.

Prior to provision of the service, the node may confirm that the requested service may be accommodated by the available storage (operation 230). If the storage cannot accommodate the requested storage, the node will communicate with the computing system 24. Otherwise the node proceeds to provide the requested service (operation 230).

Upon receipt of the signal, various possible actions are possible. The node would process the incoming power request and de-aggregate the commitment to each individual energy storage asset. This de-aggregation would then create individual commands to the individual control points with a rate of power and duration, assuming the request involved some form of discharge. The power available from the collective node is coupled to the grid 22 by the node 18. The system would interconnect to the utility interconnect via standard equipment following any national standards as needed. When each storage asset will only discharge or charge without individual alternating current transformation, then the local interconnect point (e.g., port 20) would have a DC-AC transformer capable of matching the grid AC signal and supporting that signal in power quality and frequency management as is needed under the interconnect standards and contracts to the local distribution utility. The node 18, the ports 20, or the like would require a maximum power management level equal to or greater than the assets within the aggregation point. Under contract, the node 18 provides reactive power from the AC or DC aggregated sources in order to provide support to the local utility grid assets for managing power quality and other services.

The node may utilize a distributed intelligence to manage individual resources to provide the requested service (operation 240). In some instances, the node will discontinue use of one or more storage resources prior to completion of the requested service. Similarly, the node may provision additional storage resources to provide the service while the request is pending. For example, there may be a requirement to maintain state of charge at some minimum level. When the node 18 detects that the minimum state of charge has been reached, the node may discontinue use of the storage resource for provision of the service. Other information may be used by the node in provisioning storage resources to provide a service including a vehicle owner profile, vehicle preferences, present price for providing a service, available capacity, service provision priorities, state of charge, and the like.

When the service need has been met, the utility computing system transmits a second signal to the node. Upon receipt, the node provides a signal to each storage asset providing service to discontinue provision (operation 250). At that point, a charge sequence may be initiated and each storage asset begins recharging. It is also possible that the battery system may be idled (no charge or discharge). Because the system has included control of the various storage assets (e.g. bus batteries), some assets may be configured for discharge, charge or idle depending on the request, schedule and other factors.

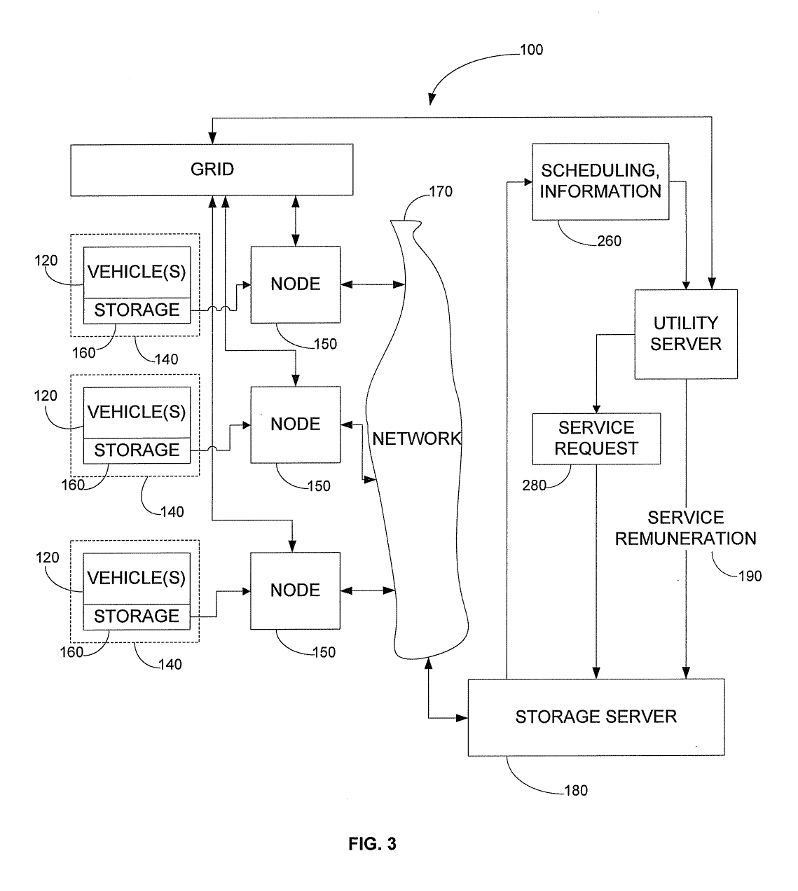

FIG. 3 illustrates an alternative energy storage system 100 configured in accordance with various aspects of the present disclosure. In this system, a third party owns the battery 160 or other storage systems associated with the various vehicles 120. The batteries are then leased, rented, or otherwise provided to the vehicle owner for a cost, which may be a fixed price based on mileage used. The system also illustrates an implementation where multiple storage locations 140 are provided under common control of a storage service control computer 180. The notions of third-party storage ownership and distributed storage locations under common control may be used alone or in combination, and may also be used in combination with other implementations set out herein.

In the system set out in FIG. 3, scheduling information 260 and requests 280 for are similar to that discussed with respect to FIGS. 1 and 2. However, the system includes, the computing system 180 that receives scheduling information from the various storage assets associated with the distinct aggregation points, correlates the scheduling information and provides it to the utility. Hence, while different storage aggregation points 140 may have different scheduling information, the system collects the scheduling information and provides a schedule to the utility that is based upon the totality of available storage assets. Each storage location 140 may have a node 150, similar to the node 18, that controls service provision with in each location 140 and communicates with the central storage service computer 180 by way of a network 170, which may be a local area network, the internet or otherwise.

Upon receipt of a service request 280, the computing system 180 determines which distributed pool or pools 140 of storage assets are available to provide the service requested, and deploys the appropriate collection of storage assets by issuing one or more commands to nodes 150. With distributed pools of assets available, similar to the system set out in FIG. 1 but with possibly greater flexibility, several advantages are possible. For example, the service may be provided in a geographic location most suitable to the request. Proper placement of these energy storage systems on the grid will be a factor in realizing the full benefit of the support services that can be provided. Since the electrical grid does not possess an even distribution of energy production and access, transmission congestion points occur. Proper placement of storage systems on the proper side of these congestion points would optimize their usefulness and even alleviate some or all of the congestion that would otherwise occur. Additionally, each individual storage asset may be managed on a charge discharge level with greater flexibility with greater assets available. For example, if 108 total buses are available at three different aggregation points, discharge from the 108 buses may be substantially less than with 36 buses. Managing depth of discharge helps improve battery life, and provides greater available immediate range when the bus comes off discharge mode.

In the various implementations discussed herein, some form of remuneration 190 may be provided for the provision of services. In the case of providing spinning reserves, the scheduling information provided to the utility provides the basis for compensation for providing the spinning reserve. Hence, a utility may pay for each megawatt of storage available to provide power in the event it is called for. Additionally, the storage provider is compensated for the actual power provided. For example, the third-party battery owner is compensated at one level for having some agreed upon level of power available if called upon, and compensated at a second level for actually providing the power when called upon. Such a situation is more economical in comparison to running a generator at some speed and then synchronizing the generator to the grid to provide power when requested. Additionally, battery storage is almost instantaneously available when called upon unlike a generator that may require 10 minutes or longer to synchronize to the grid.

Due to the nearly instantaneous nature of grid attached storage, it is also well suited for providing frequency regulation, also referred to as automatic generation control, and which may be provided in various forms including instantaneous frequency regulation, slower balancing services, as well as increasing power upward form a base level, which would be achieved by discharge, and decreasing from a base level, which would be achieved by charging.

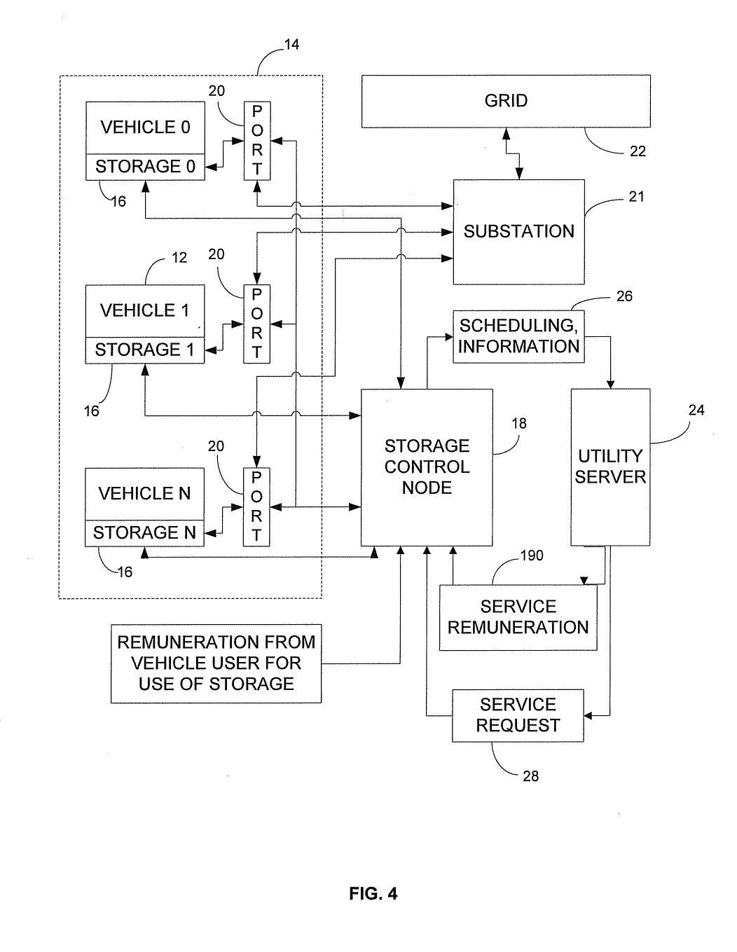

FIG. 4 is a diagram of an alternative storage system. The system of FIG. 4 is similar in scope to the system of FIG. 1, with some exceptions. In FIG. 4, the ports 20 are coupled with the grid. Hence, battery system charging and service provision is provided through the ports. Additionally, the system is configured for third party ownership of the battery systems. Here, the lease, rental, or other use rate for the battery systems may be set at a rate that could be considered a fuel hedge. For example, a fixed price per mile of usage may be set for a period of time. Hence, a fleet owner or manager, such as a school district, would not be subjected to either the varying costs of gasoline or diesel fuel, or utility rate fluctuations.

Additionally, the system may be mobile deployed or otherwise employed for demand charge hedging. Hence, the vehicles and various possible combinations of communication and control points (18, 20, 150, 180) may be mobile or deployed at various strategic locations adjacent or otherwise able to provision energy to specific buildings, campuses of buildings, cities, regional infrastructure, transmission lines and the like. It is often the case that utility rates may be adjusted upward based on peak demands. Hence, for example, in the case of a stadium, the overall campus rates may rise based on intermittent use of a stadium that has relatively high energy demand. Hence, electricity is stored with the storage assets, and the vehicle are deployed to provide a pool 14 adjacent the facility with high peak demands and delivers power for the peak demand thereby reducing the need for higher capacity long distance transmission and distribution infrastructure, and possibly reducing rates that would otherwise rise from peak demands.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic instructions.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

1. A method of providing a grid service comprising:
at least one computing device in communication with at least one tangible storage media, the tangible storage media including computer executable instructions arranged to perform a method of:
receiving information from a plurality of vehicle storage systems, the information including an indication the availability of the plurality of vehicle storage systems, ability to provide at least one energy service;
transmitting a first signal to a utility computing system indicative of the plurality of vehicle storage systems availability to provide the at least one energy service;
receiving a second signal from the utility computing system requesting the at least one service; and
transmitting a third signal to the one or more of the plurality of vehicle storage systems to provide the at least one requested service.

2. The method of claim 1 further comprising:
receiving information from the plurality of vehicle storage systems including a battery system with storage capacity sized for provision of at least one energy service, the information including an indication of the state of charge of the battery system, the plurality of vehicle storage systems associated with a respective plurality of vehicles;
transmitting a first signal to a utility computing system indicative of stored energy from the plurality of battery systems available to provide the at least one energy service;
receiving a second signal from the utility computing system requesting the at least one service;
transmitting a third signal to one or more of the plurality of battery systems to provide the at least one requested service;
receiving remuneration from at least one owner of the plurality of vehicles for use of the respective plurality of vehicle storage systems; and
receiving remuneration form the utility computing system for providing the at least one requested service.

3. A system for providing grid storage comprising:
at least one computing device in communication with a plurality of battery control computing nodes configured to communicate with to a plurality of vehicle drive battery systems;
the at least one computing device further configured to receive information concerning the plurality of vehicle drive battery systems, the information including a state of charge of the plurality of vehicle drive battery systems;
the at least one computing device further configured to transmit vehicle drive battery system scheduling information to a utility energy provider computing system, the scheduling information including information indicative of availability of the plurality of vehicle drive battery systems to provide at least one service;
the at least one computing device further configured to receive a request from the utility energy provider computing system to provide the at least one energy service, the at least one computing device signaling the plurality of battery control computing nodes to control provision of the at least one energy service from the plurality of vehicle drive battery systems.

4. The system of claim 3, the plurality of battery control nodes including at least one processor, charging electronics and discharging electronics, and further configured to control energy distribution from a connected vehicle drive battery system to a grid or to control energy distribution from the grid to the connected vehicle battery system in response to the signaling received from the at least one computing device.

5. The system of claim 3 wherein the at least one service includes at least one or more of a spinning reserve and frequency regulation.

6. The system of claim 3 wherein the at least one computing device configured to receive a connect signal when one of the plurality of vehicle drive battery systems is connected to a respective one of the plurality of battery control nodes and available for provision of the at least one energy service.

7. The system of claim 3 wherein the at least one computing device is under control of a third party other than the utility energy provider or an owner of the vehicle.

8. The system of claim 3 wherein the at least one computing device is configured to process remuneration from the utility energy provider.

9. The system of claim 8 wherein the third party has an ownership interest in the vehicle battery system, the at least one computing device configured to process remuneration from an owner of the vehicle in exchange for using the battery system.

10. The system of claim 9 wherein the remuneration from the owner of the vehicle being based on conventional vehicle fuels costs including gasoline and diesel fuel costs, the remuneration from the owner being fixed for a period of time.

11. The system of claim 10 wherein the remuneration from the owner is fixed for a period of time regardless of changes in conventional fuel costs or changes in electric rates for charging the battery system during the period of time.

12. The system of claim 3 wherein the vehicle drive battery system is optimized for providing a service and not for provide motive force for the vehicle.

13. A system for providing grid storage comprising:
at least one computing device in communication with a plurality of battery control computing nodes configured to connect to a plurality of vehicle drive battery systems, the at least one computing device associated with an owner of the vehicle drive battery systems, the at least one computing device configured to receive remuneration for use of the plurality of vehicle drive battery systems from at least one owner of a plurality of vehicles associated with the plurality of vehicle drive battery systems that provide motive power to the plurality of respective vehicles;
the at least one computing device further configured to receive information concerning each vehicle drive battery system, the information including a state of charge;
the at least one computing device further configured to transmit vehicle drive battery system scheduling information to a utility energy provider computing system, the scheduling information including information indicative of availability of the plurality of vehicle drive battery systems to provide at least one service;
the at least one computing device further configured to receive a request from the utility energy provider computing system to provide the at least one service, the at least one computing device providing a service signal to the plurality of battery control computing nodes to control provision of the at least one energy service from the plurality of vehicle drive battery systems, the at least one computing device further configured to receive remuneration from the utility energy provider computing system for the provision of the at least one energy service.

14. The system of claim 13 wherein the at least one service includes at least one or more of a spinning reserve and frequency regulation.

15. The system of claim 13 wherein the remuneration from the owner of the vehicle is based on conventional vehicle fuels costs including gasoline and diesel fuel costs, the remuneration from the owner being fixed for a period of time.

16. The system of claim 13 wherein the remuneration from the owner is fixed for a period of time regardless of changes in conventional liquid fuel costs during the period of time.

17. The system of claim 13 wherein the remuneration from the owner is fixed for a period of time regardless of changes in electric rates for charging the battery system during the period of time.

18. The system of claim 13 wherein the plurality of vehicle drive battery systems are included in a respective plurality of fleet vehicles, the vehicle drive battery systems including a capacity substantially greater than capacity.
